(19) United States
(12) Patent Application Publication
(10) Pub. No.: US 2007/0023137 A1
(43) Pub. Date: Feb. 1, 2007

(54) Adhesives for vehicle body manufacturing

(76) Inventor: Peter W. Merz, Wollerau (CH)

Correspondence Address: BINGHAM, MCCUTCHEN LLP, THREE EMBARCADERO CENTER, 18 FLOOR, SAN FRANCISCO, CA, 94111-4067, US

(21) Appl. No.: 11/541,637

(22) Filed: Oct. 3, 2006

Related U.S. Application Data
(63) Continuation of application No. 10/661,499, filed on Sep. 15, 2003, now abandoned.
Application No. 10/661,499 is a continuation of application No. 09/705,820, filed on Nov. 6, 2000, now abandoned.

(51) Int. Cl. B32B 37/00

(52) U.S. Cl. 156/275.7; 156/272.2; 156/307.1; 156/307.7; 156/327; 156/216

(57) ABSTRACT

Two-component systems are described which are suitable for underlining, adhesive bonding of the crimped fold and sealing of auto body sections, particularly for crimped fold sealing of add-on vehicle parts. The two-component systems attain the requisite grip strength for mounting the add-on parts on the body as well as the requisite strength and dimensional stability for the production process up to and with the CIP passage, within the predetermined cycle time, on the basis of cross-linking of the sealant composition twice. In one embodiment, the surface of the two-component system is pre-cross-linked by a UV-induced reaction and by the cross-linking of the two-component system to the extent of portability. In addition, two-component systems are described which cross-link intentionally only partially up to a consistency that permits a rugged course of the process through cleaning baths and which harden completely only by means of a further hardening process, for instance in the CIP forced circulation oven.

### CROSS REFERENCE TO RELATED APPLICATIONS

This application is a continuation of U.S. patent application Ser. No. 09/705,820, filed on Nov. 6, 2000, the entire content of which is hereby incorporated by reference.

### FIELD OF THE INVENTION

The present invention pertains to special adhesive, sealing and coating materials which are used as process materials, for instance in vehicle body manufacturing, and methods for their use. Uses that can be mentioned among others are adhesive bonding of the crimped fold and crimped fold sealing (also known as fine-seam sealing), coarse-seam sealing and structural adhesive bonding to the body, and the underlining for instance of add-on parts. The materials according to the invention make improved quality possible at lower process costs, in particular for crimped fold sealing.

### BACKGROUND OF THE INVENTION

In crimped fold sealing in motor vehicle manufacture, a curable material is placed, in particular in the form of a bead, over the region of the fold that is open toward the outside. This material solidifies in a first hardening process, such as inductive heating of the sheet metal in the region of the hardenable composition. The material is cured completely in a subsequent hardening process, in particular in a forced-air CIP oven (oven downstream of the cathodic immersion paint or CIP bath). As the hardenable composition, PVC is used here in particular.

This method presents problems whenever the hardenable material covers air inclusions or has incorporated liquids or gases before the final hardening that expand in the later oven hardening and form bubbles that are visible from outside. These bubbles adversely affect the appearance (sacrifices in terms of appearance) and form weak points in the anti-corrosive sealant.

In an alternative production in the manufacture of add-on vehicle parts, such as doors, trunk lids and hoods, sliding roof covers, and so forth, two sheet-metal parts are joined together. In the body in white phase, an adhesive is first applied along the edge of the outer part to the oiled metal sheet in a layer thickness of approximately 0.2 mm. The oiled metal sheet usually comprises steel, hot-galvanized or electrogalvanized steel or aluminum. The adhesive application is generally done by applying a bead, and in particular by swirl spraying. After the inner part is inserted, the outer edge of the outer part is crimped around the periphery of the inner part. The corrosion-threatened edge of the outer part is only afterward sealed in the painting process, usually by hand using a sealant, such as PVC plastisols. For production and quality-related and economic reasons, there is a desire to take the crimped fold sealing process out of the painting process and shift it back into the body in white phase. In other words, no applications not associated with the function of painting (applications that impair the paint surface) should take place in the painting process itself. Until now, this need has not yet been met to satisfaction, since no reliable economic method concept and adhesive materials for this purpose have been available.

In German Patent Disclosure DE 33 14 896 A1, an adhesive for crimped fold sealing is described which pre-cross-links by means of ultraviolet (UV) irradiation. The adhesive is thermally cured completely in the oven after passing through the cleaning baths, at a temperature around 180° C., together with the CIP priming. Although this adhesive has the advantages over hardening by UV irradiation, it also has the disadvantage that the action and thus also the cross-linking take place only from the outside inward. With relatively great layer thicknesses of more than 0.3 mm, adequate pre-cross-linking is no longer assured even with a relatively long irradiation time, and the layers located beneath remain uncross-linked, in a paste-like state. This paste-like layer located under the pre-cross-linked surface can have serious adverse effects on the visual quality of the sealant. First, since structural parts are sometimes carried around by hand, the adhesive of the sealant, while it can be touched, is not yet strong enough to grip. This means that fingerprints can adversely affect the appearance. Second, adhesives, especially in the uncross-linked state, have the tendency to absorb moisture, which leads to the formation of bubbles in the thermal action performed in the forced-air CIP oven. This aforementioned disadvantage is significant in the sense that for economic reasons it is desirable to produce the structural parts in finished form at a central point, i.e., including the sealing, and from there, shipping them to outside production lines, even those located all over the world. From there, they pass directly into cleaning baths—which is the first portion of the painting process. A considerable potential savings exists since the outside production lines can dispense with a body in white, as well as the sealing, which is undesired anyway in the painting process, but this is on the condition of a certain strength on the part of the layer.

Moisture-hardening or thermally hardenable single-component adhesives are also already known. Moisture-reactive single-component systems would indeed harden thoroughly, but they have major disadvantages. For example, the hardening depends among other factors on the water vapor diffusion and is thus too slow for production lines.

Thermally hardenable single-component adhesives are dependent on maintaining the process sequence precisely, since under inadequate hardening conditions, such as the lack of sufficiently high temperatures over the entire region, the adhesive cross-links incompletely, and thus the required function is not achieved. Such adhesives are usually based on binders that contain epoxy groups and that do not cross-link until above 130° C., and even better around 180° C., with a thermally unstable hardener.

In vehicle body manufacturing, systems that contain PVC or polyacrylate are thermally pre-solidified by means of induction, so that they will not be leached out in the cleaning baths. However, it has been found in practice that a precise thermal process course is impossible with the induction systems currently available. A temperature difference of up to 80° C. or more occurs not infrequently along the induction loops around the structural part. Furthermore, the induction is very sensitive, which has an effect on the location of the induction loop relative to the structural part. This position can be changed by external factors, such as maintenance, impacts or jarring, which as a consequence has a direct influence on the thermal action and thus leads to incorrect hardening (either uncross-linked, or over-fired). Induction heating is therefore not rugged enough for thermally hardenable systems, especially with short cycle times, since a very high heat impact is required here in a short time.

### OBJECT AND SUMMARY OF THE INVENTION

It is therefore an object of the present invention to furnish an adhesive that can be applied to the body in white, for instance, without having to make major changes in already existing systems and production sequences; which quickly becomes touchable; and which has a fundamental strength sufficient even for shipping the “body-in-white” or oiled add-on parts anywhere in the world, a process also known as completely knocked down or CKD shipping. In a broader sense, the visual quality of the crimped fold sealing should also be assured. Even after the add-on parts have been shipped for a relatively long time through various climatic zones this crimped fold sealing should remain satisfactory and should have a smooth surface without craters, cracks and the like. Furthermore, by means of the special adhesive, a method is made possible which can be introduced into the body in white phase without major investment, and with which substantial production advantages can be obtained.

This goal has been attained by finishing a two-component adhesive and a method for employing the two-component adhesive system.

With the two-component adhesives, sealants and coating materials according to the invention, crimped fold sealing and underlining adhesive bonding, for instance, can be performed in such a way that bubble development in the later oven treatment is suppressed. Good handling of the sealed parts in the overall process is therefore assured. A suitable method, particularly for the crimped fold sealing of add-on vehicle parts, is therefore also a subject of the present invention. With the novel method system, the course of production is simplified substantially, and quality is enhanced.

In a preferred embodiment, sacrifices in terms of appearance caused by air inclusions, for instance, of the kind sometimes obtained in standard sealing processes, for instance using a pre-solidifiable single-component PVC or acrylate-based adhesive, such as PVC plastisol, are to be reduced, and preferably such sacrifices are to be averted entirely.

### BRIEF DESCRIPTION OF THE DRAWINGS

The special problems in terms of the visual quality of the crimped fold sealing are shown in the drawings.

FIG. 1 shows a section through a door fold with well-applied sealant; and

FIG. 2 shows a section through a door fold with a possible sealant problem.

### DESCRIPTION OF THE PREFERRED EMBODIMENTS

The reference numerals in the drawings have the following meanings:

1 Door fold

2 Inside panel

3 Outside panel

4 Crimped fold adhesive

5 Sealant composition

6 UV-hardened surface

7 Air inclusion

a, b Metal panel displacement

The two-component system according to the invention has one resin component and one hardener component and is characterized in that hardening occurs because it cross-links by means of at least two non-identical hardening processes. One hardening process is a reaction proceeding at room temperature between at least one resin and at least one hardener. At least a further cross-linking system is present which cross-links by means of a hardening process in which the active ingredients of the cross-linking system react by means of a photochemical and/or thermally activatable reaction. Typically, the active ingredients of the cross-linking system that hardens by means of photochemical reaction contain both a resin that may be reacted by means of a photoactivator and a photo-inducible photoactivator. The active ingredients of the cross-linking system that hardens by thermal activation contain both a resin that may be reacted by means of a thermoactivator and a thermoinducible thermoactivator. In addition, in special two-component systems according to the invention a hardening process by means of moisture is possible.

While the two-component reaction between resin and hardener is intended to assure a sufficiently long pot life, at least one further hardening process (induced thermally or photochemically) is conceived of for a rapid cross-linking reaction, in order to assure good wetting of the surface.

For many applications, a hardening that takes place in at least two stages is preferred, where at least the first stage leads to only partial cross-linking. It is often especially preferred that as a result of the partial cross-linking, a consistency or strength results which makes a rugged process in auto body construction possible up to and with a CIP passage.

To enable adequate wetting, especially of grease-coated surfaces, a pot life of at least 30 minutes is desired, and optionally attained in that the two-component reaction is not set into motion until by a brief thermal heating, in particular a heating to 50-150° C.

According to the invention, under certain conditions rapidly hardening ingredients of the adhesive composition are combined with at least one system that cures upon contact between the resin component and the hardener component. Appropriately, the adhesive is manufactured such that even in the event of nonhomogeneous mixing in the end product, no unreacted resin components and hardener components remain. In the cured state, the best and most homogeneous possible material properties are thereby attained. A two-component system is therefore conceived of such that the active ingredients of the one hardening process include or comprise compounds which can react with at least one active ingredient of at least one other hardening process and/or water, and substances reacting with one another at room temperature without activation are packed in different components of the two-component system.

For many uses, it is especially advantageous if one of the hardening processes is a photochemical reaction.

An especially preferred two-component system includes a resin/hardener system that reacts upon contact, i.e., independently of any special activation, as well as a photochemically reacting system containing resin and activator, and a thermally activatable system that also contains resin and activator. How such systems can or must be distributed to the two components will be described later herein. As resin for photo-induced reactions, acrylates are particularly suitable; for thermally hardening or conventional two-component hardening systems, the presence of epoxy resins is preferred, because they have good wetting and adhesion properties even on oiled surfaces.

Substances that are preferred within the scope of the present invention are listed below:

Photoactivators (UV initiators):

UV initiators are additives in radiation-hardening systems, which by absorption of ultraviolet or visible radiation form reactive intermediate products, which can trip a polymerization reaction.

a) Radical photoinitiators such as alpha splitters, bimolecular ketone-amine systems, benzil monoketals, acetophenone derivatives and monoacyl phosphine oxides, diacyl phosphine oxides, alpha-acyl oxime esters, thioxanthones, alpha-sulfonyl oxyketones, and titanocenes, such as 2,2-dimethoxy-1,2-diphenyl ethanone, (1-hydroxycyclohexyl)phenyl methanone, 2-hydroxy-2-methyl-1-phenyl-1-propanone, alpha-diphenyl methanone, 2,2-diethoxyacetophenone, diphenyl-(2,4,6-trimethylbenzoyl)-phosphene oxide, and 2-isopropylthioxanthone.

b) Ionic photoinitiators, which release Lewis acids or protons, such as ferrocenium complexes and triarylsulfonium salts.

Thermoactivators (thermally unstable hardeners):

Cyanoguanidines, imidazoles, urea derivatives such as urones and tertiary amines, organic peroxides, pinacols, azo compounds, thiurames, BF₃ adducts, and mixtures thereof.

Epoxy Resins (high- or low-viscosity):

Polycondensation or polyaddition resins, which contain at least one epoxy group and can also be adducts with unsaturated or saturated fatty acids or monomer or polymer compounds terminated with amine groups.

Preferred polycondensation products are those of bisphenol A and/or F with monofunctional aromatic and/or aliphatic glycidyl ethers, and their products of esterification.

Further examples of epoxy resins are a) polyglycidyl and poly(β-methylglycidyl) esters that can be obtained by reacting a compound having at least two carboxyl groups in the molecule with epichlorohydrin or β-methylepichlorohydrin, or by reacting a compound with at least two free alcoholic hydroxy groups and/or phenolic hydroxy groups and epichlorohydrin or β-methylepichlorohydrin, b) poly(N-glycidyl) compounds, c) poly(S-glycidyl) compounds, and d) cycloaliphatic epoxy resins.

Modified liquid resins, plastified and special resins, solid and semisolid epoxy resins and their solutions, such as epoxy Novolak resins, heterocyclic epoxy resins, and reactive-diluted epoxy resins can also be mentioned.

Compounds with activated double bonds, for instance, allyl groups, vinyl groups, acrylate groups, conjugated double bonds, etc. For example, compounds containing (meth)acrylate groups can be low molecular and high molecular.

Low molecular compounds are also called monomers and examples are epoxy (meth)acrylates, trimethylol triacrylates, etc.

Higher molecular compounds can, for instance, be adducts, on the basis of polyether, polyester or polyurethane, for example. Aromatic, aliphatic and/or cycloaliphatic diisocyanates suitable for preparing polyurethane acrylates can be used, such as commercially available ones like 2,4- and/or 2,6-toluylene diisocyanate, m-phenylene diisocyanate, xylylene diisocyanate, 4,4′-bisphenylene diisocyanate, 1,4-tetramethylene and/or 1,6-hexamethylene diisocyanate, 1,4-cyclohexylene diisocyanate, 1,5-tetrahydronaphthaline diisocyanate, methylene dicyclohexylene diisocyanate, and the like.

For the partial reaction of the terminal isocyanate groups, corresponding esters with a hydroxyl group in the ester-forming alcohol function of the (meth)acrylate ester molecule are also especially suitable. A characteristic example for this is hydroxyethyl acrylate or hydroxymethacrylate.

Fillers:

Examples of fillers that can be used according to the invention are inorganic, mineralogical and organic fillers, such as carbonates, sulfates, silicates, silicic acids, oxides/hydroxides, and fibers; beadlike fillers, soot, plastic fillers, pigments and dyes, as well as fillers capable of physical gelation under the influence of temperature.

Polyols:

To prepare oligomeric urethane precursor products, along with the usual aromatic, aliphatic and/or cycloaliphatic polyisocyanates, corresponding diisocyanates in particular are used, which in the preferred embodiment are polyols, and in particular diols, of selected molecular weight ranges: polyester polyols, including trimethylolpropane, 2,2,-dimethyl-1,3-propanediol, propane-butane- and hexanediol and dicarboxylic acids or their anhydrides (phthalic acid, hexahydrophthalic acid, isophthalic acid, maleic acid or adipic acid), polyether polyols and polyacrylate polyols, glycerol, ether with polypropylene glycol, glycols, glycerol poly(oxypropylene) triol, glycerol polyether with polypropylene oxide, glycerol polypropylene glycol ether, glycerol tri(polyoxypropylene) ether, glycerol polypropylene glycol triether, glycerol tri(polyoxypropylene) ether, glycerol polypropylene glycol triether, glycerol tri(polyoxypropylene) ether, glycerol propylene oxide polyether triol, glycerol propylene oxide polymer.

Cross-linking agents or chain-lengthening agents can also be used, such as monoethylene glycol, diethylene glycol, triethylene glycol, butane-1,4-diol, hexane-1,6-diols, trimethylolpropane, glycerine, etc.

Hardeners:

As hardeners, polyamines, amine adducts, polyaminoamides, ketimines (latent amine), and isocyanate-terminated monomers and polymers can all be used.

Catalysts/Accelerators:

To accelerate the two-component reaction and also to speed up thermal final curing, tertiary amines, acids such as mineral acids, carboxylic acids such as salicylic acid, sulfonic acids, and metal organic compounds can be used.

In accordance with the present invention, the hardening of the two-component system according to the invention (also called adhesive, sealant or sealant composition) takes place, for instance in a sealing process, by the complete cross-linking of the two-component system of the invention, combined with at least one further reaction. This at least one further reaction can be a reaction that proceeds quickly with activation, which, when performed at the beginning of the cross-linking, causes rapid partial hardening. Such reactions that lead to a partial hardening are for instance a photochemical reaction, which is induced by light, especially UV light, and/or a thermally activated reaction. In the photochemical reaction, for instance by UV light, it should be noted that depending on the type of sealant, the UV light has a penetration depth of approximately 0.01 to 1 mm, so that at least surface hardening of the sealant is attained. A deeper penetration of the UV radiation is also possible but is strongly dependent on the material and becomes less and less in lower-lying layers.

Alternatively, or in conjunction with a photochemically setting system, a system that hardens rapidly under the influence of heat can also be present in the adhesive and can contribute to the desired touchability and early strength. If such a system is used to increase the early strength, then at least portions are exposed to elevated temperature, such that at least in some places rapid hardening is attained. Complete curing of a system that hardens rapidly under the influence of heat may—if not already done—be achieved for instance in the CIP oven. The invention will be described below for an adhesive with a system that hardens by photoinduction.

The application of the sealant is advantageously done in a thickness of 150-4000 μm, and in particular in the range from 350-1000 μm. The sealant is preferably applied in the form of a bead, and the bead application can be done in the form of a swirl, for instance.

Light-induced hardening, in particular by means of UV light, can advantageously be done immediately after the application of the sealant, and preferably no later than a few minutes after the application. The UV irradiation can be done simultaneously with or before or after a supply of heat, in particular IR hardening, hot-air blower hardening or induction hardening, in which the sheet-metal regions to be sealed, or sheet-metal regions immediately adjacent to them, are heated.

Heating of the fold region immediately before the application of the sealant composition also aids in preventing bubble formation, which is sometimes caused by trapped air between the crimped fold adhesive and the sealant layer (in this respect see also European Patent Disclosure EP 0 254 870 A2).

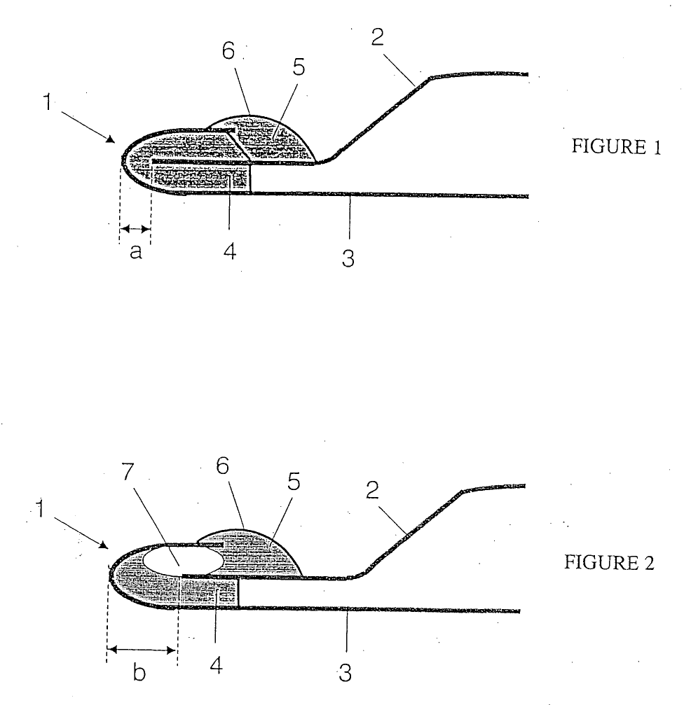

The problems relevant in this respect are illustrated in FIGS. 1 and 2. FIG. 1 shows an outer door panel 3, which is folded over an inner door panel 2 and is joined in the region of the fold 1 with a crimped fold adhesive 4. The crimped fold adhesive 4 is applied before the folding and is dimensioned in terms of its quantity such that at a spacing a (between the inner door panel 2 and the folding bend) it fills the entire fold region. A sealant 5 is applied over the outer fold region 1, and is cross-linked to such an extent, by UV irradiation 6 from outside and by the cross-linking of the two-component system, that it has grip strength, is resistant to being leached out, is sealed against gases swelling out from inside, and is sealed against the invasion of gases or liquids from outside.

FIG. 2 shows the same fold 1 as in FIG. 1, but with a displacement b of the inner door panel 2 relative to the outer door panel 3, so that the quantity of crimped fold adhesive 4 introduced does not completely fill up the fold. As a result, by means of the overcoating with the sealant 5, an air bubble 7 can be trapped, which in the hardening processes performed up to now in the forced-air CIP oven and causes the sealant 5 to swell. In the method according to the invention, however, the sealant 5 is prehardened in a double way, by UV-induced hardening 6 and by the cross-linking of the two-component system, so that in a later final hardening in the forced-air CIP oven, the trapped air bubble 7 can no longer break through.

If the UV irradiation is done immediately after the sealant application, care must be taken that the entire layer thickness of the sealant coating will not be pre-cross-linked, since the time would be too short for optimal wetting. Good wetting down to the sheet metal cannot occur until after the absorption of the oil located on it and is the fundamental prerequisite for achieving a corrosion-resistant adhesion to the sheet metal.

Since the two-component system also cross-links along with the rapidly hardening components, leaching resistance and grip strength are achieved regardless of thermal hardening conditions when the processing prescription is adhered to, i.e., the mixture ratio and mixing quality are adhered to. The hardening time can be shortened substantially by heating the sealant slightly; the heating should be done below a maximum of 150° C., and preferably below 120° C., because otherwise there is the risk of warping of a structural part. Thermal sources that can be considered include induction, infrared (IR) irradiation, hot-air blower, and so forth. In the case of IR irradiation or a hot-air blower, the expensive capital cost for an induction system can indeed be dispensed with, but these methods are not as productive as inductive heating.

When the add-on parts, such as a-door, are mounted on the vehicle body, they may have to be adapted to the body by manual correction. The sealant composition should accordingly have a grip strength such that when the add-on parts are manually twisted, no fingerprints or impressions are left behind on the surface of the sealant.

The surface sealed with the sealant composition according to the invention has grip strength within a short time after application and is protected against the invasion of gases or liquids into the sealant, so that no bubbles will be thrown off in a later thermal hardening in the forced-air CIP oven. Furthermore, by the already existing surface hardening, an escape of already trapped gases in a thermal hardening process is suppressed or even prevented.

In a preferred embodiment, the UV-reactive two-component system has a very long pot life, and the cross-linking reaction is first set into motion by a brief thermal heating, and then after the heat source is removed still proceeds exothermically at high speed. A long pot life has the advantage that on the one hand the processing is rugged and that the mixing unit does not have to be replaced after every slight interruption, and on the other, the two-component system can develop better wetting and adhesion to the oiled metal substrate, since a high-speed two-component system is already hardened by the time the adhesive has absorbed the oil present on the substrate and has wetted the sheet metal. To achieve functional wetting, care must be taken to adhere optimally to the parameters in terms of time after the application on the one hand and extent of thermal heating (dwell time at a temperature level) on the other. In addition, depending on the consistency of the two-component system, processing at slightly elevated room temperature (<60° C.) is necessary, to reinforce favorable wetting. This is true particularly for thermoplastic two-component systems.

Taking the above-described problems into account and to achieve the best possible quality or long-term performance, for a short cycle time (for instance, less than one minute), only those portions of the sealant as are touched by the worker as he straightens the add-on part should be subjected to high thermal heating. The sealant composition on the portions not thermally pretreated continue to cross-link at room temperature and depending on the process sequence, within typically two and more hours up to the cleaning baths and for the CIP passage, they achieve a sufficiently high strength for these further processing operations.

In an alternative feature of the invention, after the cross-linking of the two-component system and optionally after the UV-irradiation-induced or thermally-induced cross-linking, the adhesive is not yet completely cured. On the other hand, it has an adequate strength for the CIP passage as well as sufficiently plastic ingredients, which aid for instance in preventing breakage in the adhesive in the underlining adhesive bonding or in preventing cracking of the sealant composition in the passage through the CIP oven. At the same time, stresses are compensated for, so as not to leave any visible mark or imprint. The risk of cracking or marking exists especially whenever the two components, the inside part and the outside part, are heated and also cooled at different rates. This leads to displacement of the two parts in the region of the lap-joint flange or to sheet-metal deformation (warping) in the underlining adhesive bonding.

Since the UV-active two-component system according to the invention need not be completely cured for the CIP passage, and often is preferably not completely cured, it is not absolutely necessary to adhere to the mixing proportions precisely. This is in contrast to conventional two-component systems, which react primarily by reaction of the resin component with the hardener component.

The method system of the invention is based on(pre-)cross-linking the crimped fold sealing at least twice. The UV-active sealant composition is made to react by UV irradiation, and on the other hand cross-linking occurs because of the mixing of the two components of the two-component system.

The hardening from outside by means of UV irradiation partially cross-links the crimped fold sealant and results first in touchability, which is important for manual handling, and makes a substantial contribution to the grip strength; second in a leaching resistance to the liquids, circulating at high pressure and at up to 70° C., in the cleaning baths for degreasing the oiled vehicle body, the phosphating, and the passage through the CIP bath; and third, because the cross-linking has progressed, a long outdoor exposure time, even in hot and humid climatic conditions, of more than three weeks. The outdoor exposure time defines the time within which the adhesive meets the specified function and suffers no losses of quality after the complete hardening in the forced-air CIP oven, which takes place within about twenty-five minutes at temperatures of around 180° C. The adhesive in general, in the state in which it is not 100% cross-linked, tends to absorb water. In heat hardening, this leads to bubble formation, which can adversely affect both the appearance and the strength. As a result of the UV pre-cross-linking that acts from the outside inward, it is precisely the absorption capability of the outer layer that is lessened without impairing the wetting of the sheet metal.

For the component of the adhesive that cross-links under UV radiation, activated double bonds can be considered, such as compounds containing acrylate groups, in which case the tripping of the radical polymer reaction takes place via a photoinitiator, i.e., a radical former initiated with UV rays, or compounds containing epoxy groups, in which case the tripping of the cationic polymer reaction takes place via a photoinitiator, i.e., a cation former initiated with UV rays. Depending on the photoinitiator, the optimal wavelength is in the range from 200-700 nm. To achieve a satisfactory result in terms of grip strength and so forth, an irradiation duration of less than 30 seconds and in particular less than 5 seconds, at an intensity in particular of from 0.001 to 50 watts per cm², is suitable. This makes a rational process possible, in which the UV irradiation can for instance be done directly after the application of the sealant, in the same work step, by means of robots. The UV lamp is advantageously located quasi-behind the application nozzle for the sealant.

Furthermore, in a preferred version, the reaction induced by UV irradiation can be accelerated, as can the two-component system itself, by heating the sealant composition, for instance to temperatures of around 50° C. and above. This can be done by heating the sealant composition itself that is to be applied, for instance using a hot-air blower, and/or inductively via the metal part.

Heating by means of IR or hot-air blower is especially advantageous, since this markedly lessens or eliminates the risk of warping of the parts. That is, in these methods, because less heat is supplied, the parts are thermally stressed less than is the case in inductive heating, for instance.

Adverse effects on the appearance caused by air trapped in the crimped fold between the bonding adhesive and the sealant are greatly reduced, since the adhesive, with the pre-cross-linking done at least twice (UV and incipient 2K reaction and/or thermally activated) builds up a sufficiently high strength within a short time and thus prevents air from being shot in in the heating process in the forced-air CIP oven.

Since the sealing need not be done by hand in the painting department, as it is at present, but can be done in the body in white stage by means of robots in a way that saves material and is accordingly more economical, economies in terms of resources, such as space and time required in the painting department, are possible.

The adhesive system according to the invention includes advantages in terms of properties, such as good handling and positioning strength and a long outdoor exposure time, and thus meets all the requirements for reliable transportation both internally and externally. It furthermore overcomes the disadvantages of the prior art in which the quality is reduced by bubble formations. The advantages according to the invention allow such parts as doors, trunk lids and hoods, sliding roof covers, and so forth to be manufactured centrally and then shipped to outside production lines. This CKD shipping is economical, because some of the capital investment for the manufacturer of the body in white can be dispensed with.

Depending on the sealant used, care must be taken that particularly in the event of an inadequate exothermically reaction, hardening may possibly fail to occur, unless the hardening process is performed at an adequate intensity. To assure the success of the hardening process, work should accordingly be done with sufficient intensity of the parameters (UV light, heat, etc.) that bring about the hardening.

For optimal processing, the crimped fold adhesive should be capable of being applied in these layers and should have good oil wetting. After the heat hardening in the forced-air CIP oven, the requirements are good, aging-resistant adhesion to the metal substrates, a strength greater than 15 MPa, and an elongation at break of at least 5%.

To prevent the two parts, i.e., the inner part and the outer part, from displacement upon assembly of the add-on part and especially up to and during the passage through the CIP bath, the crimped fold adhesives are pre-solidified in accordance with the prior art.

The adhesive system according to the invention can be used for both the underlining and the adhesive bonding of the crimped fold as well as for the sealant itself, although, in a system cross-linked with UV, the crimped fold adhesive, because of not being irradiated with the UV, exhibits poor early cross-linking. Nevertheless, an adequate positioning strength is normally achieved, since the sealant composition also contributes to the structural strength. If desired, additional strength can be attained by means of partial thermally induced cross-linking, in which case care must be taken that the cross-linking not be too pronounced, so as not to impair the wetting. The final hardening, for instance in the presence of unreacted, UV-active acrylate groups, then takes place in the forced-air CIP oven along with the possibly present binders containing epoxy groups, by means of a thermally unstable latent hardener. The use of the same adhesive for both the adhesive bonding of the crimped fold and the crimped fold sealing also has the advantage that good temporary adhesion is assured.

For the sealant, the elongation to break should be as high as possible and should be at least 15% and even better greater than 30%, in order not to risk any cracking from thermal stresses.

In an alternative version, the two-component system according to the invention cross-links only partway and without the reaction induced with UV-irradiation, until it has such a viscoplastically deformable to rubberlike consistency, such that the adhesive, for instance used in the underlining, easily goes along with the pumping motions of the outer panel relative to the internal skeleton (a displacement apart of up to 10 mm and more) on passing through the cleaning baths and also is not flushed out of the adhesive gap by the liquids circulating under pressure and at a temperature of about 60° C. The final hardening then takes place, thermally activated, in the forced-air CIP oven. In this two-component system, the cross-linking of the two-component system is intentionally executed only in part (as described above), and the complete hardening is effected by a different hardening process, predominantly by means of heating in the forced-air CIP oven.

The above-described adhesives are as a rule formulated on the basis of epoxy technology, natural rubber technology, polyurethane technology, or acrylate technology, and so forth, and depending on the required profile also in combination with fillers, adhesion promoters, stabilizers, pigments, catalysts, suitable organic polymer fillers, etc. Some examples of such additives are provided in German Patent Disclosure DE 33 14 896 A1, which is also hereby expressly incorporated by reference, in particular with regard to the reaction conditions.

The two-component system of the invention can be made up in various ways; both components in a preferred embodiment are self-hardening, either by moisture or by the supply of heat or by the action of light. This is attained, among other ways, in that an additive required for tripping the cross-linking is admixed with the applicable type of binder. For instance, for a binder containing acrylate groups, this means adding an initiator that is activatable by UV irradiation or is thermally unstable; for a binder containing epoxy groups, it means adding a latently thermally unstable hardener, and for a binder containing isocyanate groups, it optionally means adding a moisture-sensitive latent hardener, such as ketimines or aldimines. By self-cross-linking of the individual components, complete thorough hardening and thus better properties of the cured adhesive or sealant is attained even if the components are poorly mixed.

Some examples of compositions for two-component systems according to the invention will be given below; they are intended to further illustrate the invention but in no way to limit the scope of the invention.

### EXAMPLE 1

Component A comprises at least one binder containing acrylate groups, at least one UV initiator, and at least one thermally unstable initiator, and component B comprises a hardener, such as amines, that reacts with the acrylate groups. To satisfy the requirement for self-hardening, component B can also contain at least one binder that contains silane groups. If desired, the hardener can advantageously be added in metered form in such a quantity that only partial cross-linking results; however, by this partial cross-linking, an optimal strength (viscoplastically deformable to rubberlike) for the CIP passage is attained.

### EXAMPLE 2

Component B of Example 1 can additionally contain at least one initiator for the radical polymerization of activated double bonds in Component A; in this case, partial cross-linking is less possible.

### EXAMPLE 3

Component A, in addition to the binder according to Example 1, contains at least one binder that contains epoxy groups and at least one latent hardener, to improve the adhesion to the metal sheet. Alternatively, both reactive groups, that is, the epoxy groups or acrylate groups, may be present in the same compound.

### EXAMPLE 4

Component A comprises at least one binder containing acrylate groups, at least one UV initiator, and at least one binder containing isocyanate groups, and Component B comprises at least one binder containing epoxy groups, which also has OH groups, and optionally compounds containing additional OH groups, which can be cross-linking agents or polyols, and at least one hardener that is thermally unstable for the epoxy groups.

### EXAMPLE 5

The binder containing acrylate groups, contained in Component A in Example 4, can alternatively also be present in Component B (along with the binder containing epoxy groups).

### EXAMPLE 6

The binder containing acrylate groups, which is mentioned in Examples 1-4, can be replaced by binders having other activated double bonds.

### EXAMPLE 7

Instead of, or in combination with, a binder that contains isocyanate groups, binders that contain silane groups can also be used.

While mixtures can be advantageous in the binders, in order to achieve certain material properties, typically only one initiator and/or activator and/or unstable hardener per component is present.

1. A two-component system having one resin component and one hardener component, wherein hardening is effected in that the system cross-links by means of at least two non-identical hardening processes, one hardening process being a reaction proceeding at room temperature between at least one resin and at least one hardener, and at least a further cross-linking system is present which cross-links by means of a hardening process in which the active ingredients of the cross-linking system react by means of a photochemical and/or thermally activatable reaction, and the active ingredients of the cross-linking system which hardens by means of photochemical reaction contain a resin which may be reacted by means of a photoactivator and contain a photo-inducible photoactivator, and the active ingredients of the cross-linking system that hardens by thermal activation contain a resin which may be reacted by means of a thermoactivator and a thermo-inducible thermoactivator.

2. The two-component system of claim 1, wherein, in addition, a hardening process by means of moisture takes place.

3. The two-component system of claim 1, wherein the hardening is effected in at least two stages, and at least the first stage leads to only partial cross-linking.

4. The two-component system of claim 3, wherein, as a result of the partial cross-linking, a consistency or strength results which makes a rugged process in auto body construction possible up to and with a CIP passage.

5. The two-component system of claim 1, wherein it has a pot life of at least 30 minutes.

6. The two-component system of claim 1, wherein the two-component reaction is not set into motion until by a brief thermal heating.

7. The two-component system of claim 1, wherein the active ingredients of the one hardening process include or comprise compounds which can react with at least one active ingredient of at least one other hardening process and/or water, and substances reacting with one another at room temperature without activation are packed in different components of the two-component system.

8. The two-component system of claim 1, wherein one of the hardening processes is a photochemical reaction.

9. A method for sealing an auto body section by application of a sealant composition to the body section to be sealed, followed by a multi-step hardening of the sealant composition, said method comprising:
(a) preparing a sealant composition comprising at least one resin and at least one hardener;
(b) applying the sealant composition to said body section at room temperature to initiate hardening of the sealant composition; and
(c) cross-linking the sealant composition by a photochemical and/or thermally activatable reaction; wherein the active ingredients of the cross-linking system which hardens by means of photochemical reaction include a resin which reacts by means of a photoactivator and a photo-inducible photoactivator, and the active ingredients of the cross-linking system that hardens by thermal activation include a resin which reacts by means of a thermoactivator and a thermo-inducible thermoactivator.

10. The method for sealing an auto body portion according to claim 9, wherein before passing through a cathodic immersion paint (CIP) oven, the system is at least partially cured by means of thermal induction and/or a photoinduced hardening process.

11. A method for crimp fold sealing a metal auto body section by application of a sealant composition to a body section to be sealed, followed by hardening of the sealant composition, wherein the sealant composition comprises at least one resin and at least one hardener, and the hardening is effected by means of at least two non-identical hardening processes, one of the hardening processes including a room temperature hardening and at least one further hardening step including a photochemical and/or thermally activatable hardening.

12. The method of claim 11, wherein one hardening process is a photochemical hardening.

13. The method of claim 9, wherein the photochemical hardening and/or thermally activatable hardening is performed before a coating or wetting of the body section.

14. The method of claim 11, wherein partial hardening is performed before painting of the body section.

15. The method of claim 11, wherein the sealant composition is hardened by means of two non-identical hardening processes, which are performed before coating or wetting of the body section.

16. The method of claim 11, wherein one of the hardening processes comprises a photochemical reaction which primarily hardens the outer surface of the sealant, and the at least one other hardening process comprises a reaction which hardens either a contact region of the sealant with the body section, or internal regions of the sealant.

17. The method of claim 11, wherein one hardening process is a thermal hardening by partial heating of the adhesive and/or, at least in a first stage, is effected without an oven.

18. The method of claim 11, wherein the non-identical hardening processes are performed at a time interval between them of less than 2 hours.

19. The method of claim 18, wherein the hardening processes are performed in a time interval between them of less than 1 hours.

20. The method of claim 11, wherein the hardening processes are selected from oven hardening, inductive hardening, hardening by a hot-air blower, photochemical cross-linking, reactive rehardening without a special energy supply, or combinations thereof.

21. The method of claim 11, wherein the hardening processes effect at least a partial hardening and are performed to at least a surface hardness of the sealant composition that is sufficient for touchability or grip strength for manual handling, and/or up to a leaching resistance in circulating cleaning baths at a temperature of up to 70° C. for degreasing oily auto body parts, phosphating, and/or electronic immersion painting and/or an outdoor exposure time under tropical climatic conditions of more than three weeks.

22. The method of claim 11, wherein partial hardening of at least one of the non-identical hardening processes is effected until the sealant has a strength at least such that in the further course of the process, sacrifices in terms of appearance from air inclusions are reduced.

23. The method of claim 11, wherein, in the basic body in white phase, a crimped fold sealant is prepared which is partially hardened with UV radiation and thermal energy together with adhesive bonding of the crimped fold in such a way that add-on parts thus produced can be transported and after passing through at least one cleaning bath and one painting operation, can be completely thermally hardened in an oven together with painting.

24. The two-component system of claim 2, wherein the hardening is effected in at least two stages, and at least the first stage leads to only partial cross-linking.

25. The two-component system of claim 24, wherein, as a result of the partial cross-linking, a consistency or strength results which makes a rugged process in auto body construction possible up to and with a CIP passage.

26. The two-component system of claim 6, wherein the brief thermal heating is in the range 50-150° C.

27. The method of claim 12, wherein photochemical hardening and/or at least one stage of a thermal hardening is performed before coating or wetting of the body section.

28. The method of claim 13, wherein the thermal hardening performed before coating or wetting of the body section is performed before degreasing and/or painting.

29. The method of claim 27, wherein the thermal hardening performed before coating or wetting of the body section is performed before degreasing and/or painting.

30. The method of claim 15, wherein the hardening performed before coating or wetting of the body section is performed before painting.

31. The method of claim 11, wherein one of the hardening processes is a photochemical reaction.

32. The method of claim 31, wherein another hardening process is a two-component reaction.

33. The method of claim 17, wherein said heating is effected by inductive heating, IR radiation, and/or a hot-air blower.

34. The method of claim 22, wherein the sealant strength is in the contact region with the body section.

35. The method of claim 23, wherein visual or functional sacrifices are not present in the sealant.

36-41. (canceled)

42. The method according to claim 9, wherein the sealant composition is a two-component composition A+B where A comprises a resin containing acrylate groups and/or epoxy groups, a UV initiator and a thermally unstable initiator and B comprises a compound reactable with acrylate and/or epoxy groups, optionally further including a compound containing silane groups.

43. The method according to claim 11, wherein the sealant composition is a two-component composition A+B where A comprises a resin containing acrylate groups and/or epoxy groups, a UV initiator and a thermally unstable initiator and B comprises a compound reactable with acrylate and/or epoxy groups, optionally further including a compound containing silane groups.
